(19) United States
(12) Patent Application Publication
(10) Pub. No.: US 2010/0109609 A1
(43) Pub. Date: May 6, 2010

(54) POWER SUPPLY MODULE

(75) Inventor: Chien-Chiang CHAN, Taipei Hsien (TW)

Correspondence Address: BRIAN M. MCINNIS, 12th Floor, Ruttonjee House, 11 Duddell Street, Hong Kong, HK

(73) Assignee: Chien-Chiang CHAN, TAIPEI HSIEN (TW)

(21) Appl. No.: 12/368,962

(22) Filed: Feb. 10, 2009

(30) Foreign Application Priority Data
Nov. 6, 2008 (TW) 97142937

(51) Int. Cl. H02J 7/00

(52) U.S. Cl. 320/128

(57) ABSTRACT

A power supply module includes a circuit board and at least one energy cell. The energy cell has a positive contact and a negative contact. The energy cell is placed on the circuit board.

### RELATED APPLICATIONS

This application claims priority to Taiwan Application Serial Number 97142937, filed Nov. 6, 2008, which is herein incorporated by reference.

### BACKGROUND

1. Field of Invention

The present invention relates to a power supply module. More particularly, the present invention relates to a power supply module with energy cells.

2. Description of Related Art

Energy storage parts play important roles in our daily lives since they influence the performance and the working time of electronic devices. Components such as capacitors used in the circuits and batteries used in portable devices are the most common energy storage parts.

Ultra-capacitors, also called Electric Double-Layer Capacitors (EDLC), have substantially high power density. In the past few years, these components have been used in consumer electronics, industrial and automotive applications. Today, ultra-capacitors with 20 kW/kg of power densities are already available, and they have very compact sizes (a small ultra-capacitor usually has a stamp size or even smaller). They can store a lot more energy than traditional capacitors. Faraday (F) is the unit of the capacitance value used by most ultra-capacitors, usually in 1F to 5000F. The discharge rate can be very quick and can also be very slow. Their life is very long and can be designed for the entire life cycle of end products.

Power supply solutions such as power supply modules or power suppliers often employ energy cells like batteries or capacitors. Previously, owning to the limitations in sizes, functionality, and life of energy cells, energy cells are typically placed outside circuit boards. However, as technology advances, energy cells like batteries or magnetic capacitors will be used in various electronic devices in the future. Therefore, there is a need to provide an application of energy cells.

### SUMMARY

According to one embodiment of the present invention, a power supply module includes a circuit board and at least one energy cell. The energy cell has a positive contact and a negative contact. The energy cell is placed on the circuit board.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a power supply module according to a first embodiment of this invention; and

FIG. 2 illustrates a power supply module according to a second embodiment of this invention.

### DESCRIPTION OF THE PREFERRED EMBODIMENTS

Reference will now be made in detail to the embodiment of this invention, examples of which are illustrated in the accompanying drawings. Wherever possible, the same reference numbers are used in the drawings and the description to refer to the same or like parts.

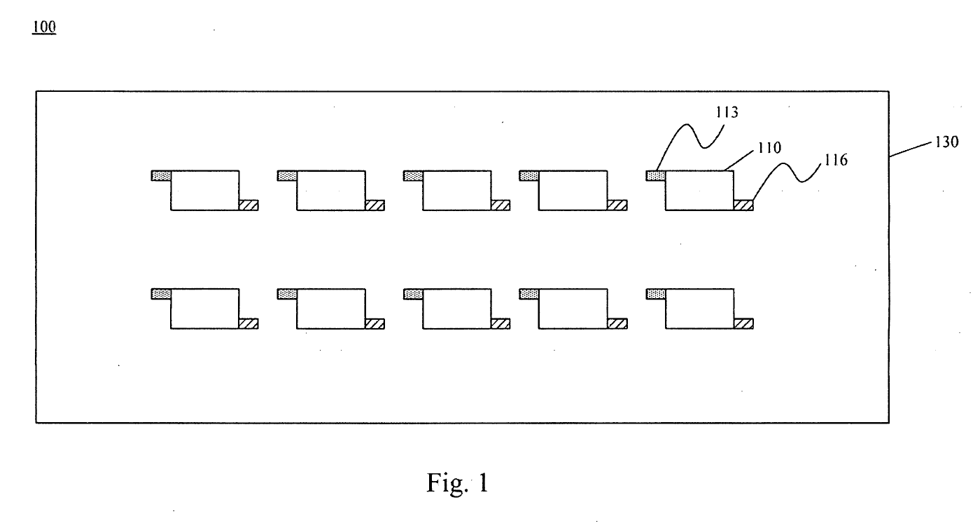

FIG. 1 illustrates a power supply module according to a first embodiment of this invention. The power supply module 100 can be used in various electronic devices. The power supply module 100 includes at least one energy cell 110 and a circuit board 130. The energy cell 110 is a high efficiency energy cell such as a super capacitor, magnetic capacitor, and miniature flat type batteries, and the size of which can achieve the size of a post stamp or even smaller. In addition, the energy cell 110 has large capacitance and can charge or discharge a great number of times. For certain energy cells, their energy densities can achieve 500 wh/kg. The energy cell 110 has a positive contact 113 and a negative contact 116. The positive contact 113 and negative contact 116 can be used to connect with a load, or to connect with another or more energy cells in serial or parallel first and then to a load. The energy cell 110 in FIG. 1 is for illustrative purpose only and not intended to limit this invention. The positive contact 113 and negative contact 116 can be arranged on the same side, neighboring sides, or opposite sides of the energy cell 110.

Because the energy cell 110 has a small size, it can be placed directly on the circuit board 130. Besides, based on the actual needs varying from application to application, the energy cell 110 may be electrically connected to the circuit board 130 in different ways. As mentioned above, the energy cell 110 to is characterized by small size, large capacitance, and a great number of charge or discharge times. Thus, such design (placing the energy cell directly on the circuit board) could save a lot of space. The circuit board 130 can be a printed circuit board, a flexible printed circuit, a ceramic circuit board or other suitable circuit boards. This power supply module 110 can also include at least one first jointing component and at least one second jointing component. The first jointing component joints the positive contact 113 and the circuit board 130; and the second jointing component joints the negative contact 116 and the circuit board 130. The material of the first and second jointing component could be gold, copper, aluminum, silver, tin, combination alloy from the above is metal, or other conductive material. The first and the second jointing component could be holes, metal bumps, metal bonding wires, solder, or other suitable conductive structure.

The energy cell 110 may be a package already completed, or may be an unpackaged cell. If the energy cell 110 is unpackaged, then the power supply module 100 also includes at least one insulating layer coating the energy cell 110. The material of the insulating layer could be Epoxy resin, ceramic, glass, or other suitable material.

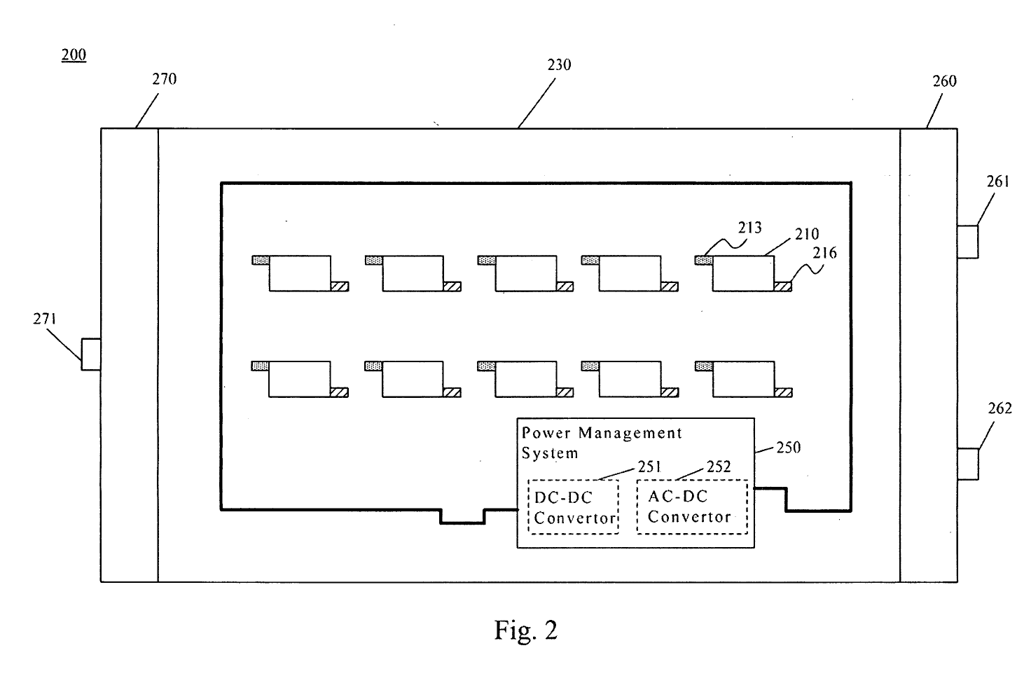

FIG. 2 illustrates a power supply module according to a second embodiment of this invention. The power supply module 200 can be used in various electronic devices. The power supply module 200 includes at least one energy cell 210 and a circuit board 230. The energy cell 210 is a high efficiency energy cell such as a super capacitor, magnetic capacitor, and miniature flat type batteries, and the size of which can achieve the size of a post stamp or even smaller. In addition, the energy cell 210 has large capacitance and can charge or discharge a great number of times. The energy cell 210 has a positive contact 213 and a negative contact 216. The positive contact 213 and negative contact 216 can be used to connect with a load, or to connect with another or more energy cells in serial or parallel first and then to a load. The energy cell 210 in FIG. 2 is for illustrative purpose only and not intended to limit this invention. The positive contact 213 and negative contact 216 can be arranged on the same side, neighboring sides, or opposite sides of the energy cell 210.

Because the energy cell 210 has a small size, it can be placed directly on the circuit board 230. Besides, based on the actual needs varying from is application to application, the energy cell 210 may be electrically connected to the circuit board 230 in different ways. As mentioned above, the energy cell 210 is characterized by small size, large capacitance, and a great number of charge or discharge times. Thus, such design (placing the energy cell directly on the circuit board) could save a lot of space. The circuit board 230 can be a printed circuit board, a flexible printed circuit, a ceramic circuit board or other suitable circuit boards. This power supply module 210 can also include at least one first jointing component and at least one second jointing component. The first jointing component joints the positive contact 213 and the circuit board 230; and the second jointing component joints the negative contact 216 and the circuit board 230. The material of the first and second jointing component could be gold, copper, aluminum, silver, tin, combination alloy from the above metal, or other conductive material. The first and the second jointing component could be holes, metal bumps, metal bonding wires, solder, or other suitable conductive structure.

The energy cell 210 may be a package already completed, or may be an unpackaged cell. If the energy cell 210 is unpackaged, then the power supply module 200 also includes at least one insulating layer coating the energy cell 210. The material of the insulating layer could be Epoxy resin, ceramic, glass, or other suitable material.

The power supply module 200 can also include a power management system 250, also placed on the circuit board 230. The power management system 250 could control the energy cells within the power supply module so as to charge or discharge the energy cells respectively, sequentially, or together. The power management system 250 could have a DC-DC convertor 251 and/or an AC-DC convertor 252.

Additionally, the power supply module 200 may include a positive plate 260 and a negative plate 270. The positive plate 260 and the negative plate 270 respectively has at lest one charging electrode and/or at least one discharging electrode such as charging electrodes 261 and 262 on the positive plate 260 and the discharging electrode 271 on the negative plate 270. The positive plate 260 is connected to a side of the circuit board 230, while the negative plate 270 is connected to the other side of the circuit board 230 opposite of the positive plate 260. Depending on the area the power supply module 230 actually applies to, the number of charging and discharging electrodes can vary. For instance, when this invention is applied to the car industry, it can have multiple charging electrodes so as to meet the demand of large power supply.

The positive contacts of the energy cells are connected to the positive plate 260; and the negative contacts of the energy cells are connected to the negative plate 270. The material of the positive plate 260 and the negative plate 270 may be ceramic, metal, glass or other suitable material The positive plate 260 and the negative plate 270 may both be printed circuit boards.

It will be apparent to those skilled in the art that various modifications and variations can be made to the structure of the embodiment without departing from the scope or spirit of the invention. In view of the foregoing, it is intended that the embodiment cover modifications and variations of this invention provided they fall within the scope of the following claims and their equivalents.

What is claimed is:

1. A power supply module comprising:
a circuit board; and
at least one energy cell having a positive contact and a negative contact, the energy cell being placed on the circuit board.

2. The power supply module of claim 1, further comprising a power management system placed on the circuit board, the power management system having a DC-DC convertor and/or an AC-DC convertor.

3. The power supply module of claim 2, wherein the power management system controls the energy cell so as to charge or discharge the energy cell respectively, sequentially, or together.

4. The power supply module of claim 3, further comprising:
a positive plate having at lest one charging electrode and/or at least one discharging electrode, the positive plate being connected to a side of the circuit board; and
a negative plate having at lest one charging electrode and/or at least one discharging electrode, the negative plate being connected to the other side of the circuit board opposite of the positive plate.

5. The power supply module of claim 4, wherein the positive contact of the energy cell is connected to the positive plate, the negative contact of the energy cell is connected to the negative plate.

6. The power supply module of claim 4, the material of the positive plate and the negative plate is ceramic, metal, or glass.

7. The power supply module of claim 4, wherein the positive plate and the negative plate are printed circuit boards.

8. The power supply module of claim 1, wherein the circuit board is a printed circuit board, a flexible printed circuit, or a ceramic circuit board.

9. The power supply module of claim 1, further comprising:
at least one first jointing component for jointing the positive contact and the circuit board; and
at least one second jointing component for jointing the negative contact and the circuit board.

10. The power supply module of claim 9, wherein the material of the first and second jointing component is gold, copper, aluminum, silver, tin, combination alloy from the above metal, or other conductive material.

11. The power supply module of claim 10, the first and the second jointing component are holes, metal bumps, metal bonding wires, solder, or other conductive structure.

12. The power supply module of claim 1, further comprising at least one insulating layer coating the energy cell.

13. The power supply module of claim 12, wherein the material of the insulating layer is Epoxy resin, ceramic or glass.
